(19) United States
(12) Patent Application Publication
(10) Pub. No.: US 2011/0088440 A1
(43) Pub. Date: Apr. 21, 2011

(54) Key with a Key Light Function

(76) Inventors: Henry Feil, Munchen (DE); Thomas Schaefer, Munchen (DE); Joachim Walewski, Unterhaching (DE)

(21) Appl. No.: 12/999,568

(22) PCT Filed: May 29, 2009
(86) PCT No.: PCT/EP09/56626

§ 371 Date: Dec. 16, 2010

(30) Foreign Application Priority Data
Jun. 16, 2008 (DE) 20-2008-008-036.3

(51) Int. Cl. E05B 19/00; F21V 33/00

(52) U.S. Cl. 70/393; 362/116

(57) ABSTRACT

A key with a key light function comprising at least one light source (5), a storage circuit (20) for storing at least one code sequence, and a driver unit (10), which converts the stored form of the code sequence into a driving output for the light source (5), wherein the code sequence can be emitted by the light source (5) at a wavelength visible to humans by means of a temporal or color variation of the luminous flux, and the light source (5) can also be used as an orientation light.

### TECHNICAL FIELD

The invention relates to a key with a key light function comprising at least one light source, a storage circuit for storing at least one code sequence, and a driver unit, which converts the stored form of the code sequence into a driving output for the light source.

The key light is considered to be a small luminaire which, on account of its compact form, is usually attached to a bunch of keys and can be briefly turned on as necessary by the user for orientation purposes. The term key denotes a key which is designed to be able to lock at least one lock intended for the key.

### PRIOR ART

Key lights in the prior art are constructed in a very simple manner and usually only have a battery, a switch or pushbutton and a light source. They can only be used as an orientation luminaire and otherwise have no functionality at all.

EP954665A1 discloses an immobilizer comprising an optical key, which, by means of infrared radiation, transmits a code sequence to an automobile lock which verifies the code and enables the engine to be started if the code is correct. The optical key is constructed as a mechanical key additionally having the optical key function implemented.

However, said key has the disadvantage that the light containing the code sequence is not visible and so it remains hidden to the user as to whether the latter actually hits the infrared receiver in the automobile lock with said user's code sequence transmitted by the key. Therefore, a plurality of attempts are usually necessary until a lock can be opened or the starting of the engine is enabled. The key emits no visible light at all; therefore, it cannot serve as a key light.

### OBJECT

It is an object of the invention to specify a key with a key light function comprising at least one light source, a storage circuit for storing at least one code sequence, and a driver unit, which converts the stored form of the code sequence into a driving output for the light source, in which key the interaction with the user and the functionality are improved.

### SUMMARY OF THE INVENTION

The object is achieved according to the invention by means of a key with a key light function comprising at least one light source, a storage circuit for storing at least one code sequence, and a driver unit, which converts the stored form of the code sequence into a driving output for the light source, wherein the code sequence can be emitted by the light source at a wavelength visible to humans by means of a temporal or color variation of the luminous flux, and the light source can also be used as an orientation light.

In order to increase the possible data rate at which the code sequence can be transmitted, the light source is preferably a semiconductor light source. If the code sequence is emitted continuously, the resulting light can be used as an orientation light. As an alternative, the light source can either emit a code sequence by means of visible light, or continuously emit the visible light as an orientation light.

In this case, the key preferably has a first switch for activating the light source. Particularly preferably, the key has two switches, wherein the first switch causes the light source (5) to emit continuously and the second switch initiates the emission of the code sequence. In this case, the key can emit light in a plurality of colors by means of its light source. In this case, it is advantageous if the key emits the code sequence in a different color than the continuous light. The user can thereby recognize when the code sequence is transmitted.

In this case, the key can store a plurality of code sequences. As a result, it can open a plurality of locks, and can thus be used more universally. It is advantageous if the key emits different code sequences in different light colors or wavelengths. The assignment of the code sequences to the different locks can thus be recognized more easily by the user.

In this case, the key preferably has a plurality of switches or pushbuttons for the selection of the different code sequences and also the continuous light, and at least one switch or pushbutton for activating the previously selected function. This brings about a logical and clear operational guidance for the user. In order to additionally simplify this, the key preferably has a dedicated switch or pushbutton respectively for the functions of unlocking and/or locking. The key emits the continuous light as white light having a mixture of at least three different wavelengths.

The key can have a light-sensitive receiver for receiving light signals. This can serve for a bidirectional signal coding method between the key and lock in order to increase the security against interception. It is advantageous if the receiver in the key is the light source itself. For long usability, the key should have a rechargeable battery. In order to improve the operational control further, the key can have optical components by means of which the emitted light from the light source can be focused forward in at least two stages.

Further advantageous developments and configurations of the key according to the invention emerge from further dependent claims and from the following description.

Since the key according to the invention comprises a light for emitting an orientation light, it is designated as a key light in the explanations below.

### BRIEF DESCRIPTION OF THE DRAWING(S)

The invention is explained in greater detail below on the basis of exemplary embodiments. In the figures:

FIG. 1a shows a block diagram of the functional units of the key light.

FIG. 1b shows a block diagram of the functional units of a lock that can be unlocked and locked by the key light.

FIG. 2a shows a perspective view of an exemplary embodiment of the key light according to the invention.

FIG. 2b shows a plan view of an exemplary embodiment of the key light according to the invention.

### PREFERRED EMBODIMENT OF THE INVENTION

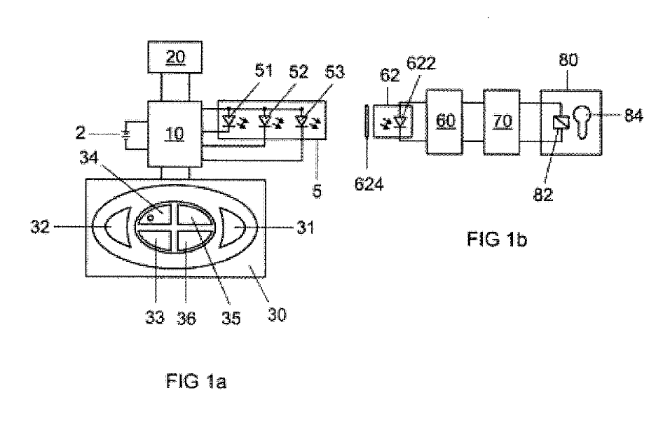

FIG. 1 shows a block diagram of the preferred embodiment of the key light according to the invention. The invention is based on the possibility of transmitting data by means of light in free space. In the preferred embodiment, different-colored light-emitting diodes are in this case used as luminous sources. Particularly preferably, in this case an RGB light-emitting diode is used, which combines 3 light-emitting diode chips in one light-emitting diode and can emit the colors red, green and blue. If all 3 light-emitting diode chips are turned on, then the light-emitting diode generates white light by means of additive color mixing. Since the light-emitting diode chips are arranged locally very closely next to one another, the human eye can no longer resolve the origin and sees white light. Therefore, it is possible, in principle, to utilize the entire structural range of the light, that is say to use white light and also colored light also as a transmission medium for data transmission.

In the preferred embodiment this data transmission possibility is used for the remotely controlled unlocking and locking of locks of all types by means of visible light. For this purpose, the key light has a battery or a rechargeable battery 2, which supplies the key light with energy. The energy is input into a central driver circuit 10 designed for operating the 3 different-colored light-emitting diode chips 51, 52, 53 of the light-emitting diode 5. In this case, the light-emitting diode chips can be driven individually. In order to be able to transmit data by means of the visible light of the light-emitting diode, the key light according to the invention also has a storage circuit 20, which stores the data in the form of different code sequences in binary form. The storage circuit is connected to the driver circuit and supplies the requested code sequences upon request to the driver circuit. The request is initiated e.g. by button pressing on one of the action buttons 31, 32 of the pushbutton arrangement. In this case, one pushbutton 31 serves for unlocking the lock, and the other pushbutton 32 serves for locking. If the button 31, 32 is pressed, the code sequence is transmitted to the driver circuit and the latter outputs said code sequence as driving current to the light-emitting diode 5. The code sequence is then transmitted by temporal variation of the luminous flux of the light-emitting diode 5. However, the code sequence can also be transmitted by temporal variation of the light color. The code sequence comprises the combination for a lock which is intended to be opened or closed.

In the preferred embodiment, it is possible to select and transmit a plurality of different code sequences for different locks. For this purpose, a keypad 30 is provided, which also has, besides the activation buttons 31, 32 for unlocking and locking as already described above, a plurality of selection buttons 33, 34, 35, 36. The desired function is preselected by means of said selection buttons, said function then being implemented by means of the action buttons. The button 34, provided with an elevation to enable it to be found more easily in the dark, selects the function ‘orientation light’, in the case of which the light-emitting diode continuously emits light in a white light color. The interior of the key light can be configured such that part of the light is also emitted inward and illuminates the transparent buttons, such that the selection buttons are illuminated by means of the orientation light that can be found easily. These three buttons 33, 35, 36 select different code sequences for different locks which are intended to be unlocked and locked. The code sequence is transmitted by one of buttons 31 or 32 being pressed. For this purpose, the emitted light power is temporally varied, and the variation of the luminous flux comprises the code sequence for the lock. However, it is also conceivable for the luminous flux to remain substantially the same, and for the color locus of the light to be altered in return. If the lock has e.g. the combination 101101 and if so-called on-off keying (switching the light on and off for ‘1’ and ‘C’) is used as a coding protocol, then said combination can be transmitted by rapid modulation to the lock (on-off-on-on-off-on). In this case, the modulation frequency is so high, i.e. the length of the transmitted symbols is so short, that no unpleasant flicker occurs in the visible light. In this case, the code sequences for the different locks are preferably emitted in different colors in order to increase the transmission security and security against interception, and to provide the user with a memory aid. Said user only has to remember one color for each lock, e.g. the red lock, the blue lock, etc. The emitted colors can be the native colors of the RGB light-emitting diode used, but also any desired mixed colors that can be represented by the RGB light-emitting diode. The lock itself can have a color filter, such that only the signals having the correct wavelength actually reach the receiving part. This considerably increases the system security since it constitutes a further coding criterion besides the number of code sequences that can be represented for the lock.

For this purpose, the locks are equipped with a light-sensitive receiving part 62, which can be provided with a color filter 624 in order, as described above, to be able to receive only the code sequences of the ‘correct color’. The signal received by a photodiode 622 is conducted through a demodulator 60 which generates a binary code sequence again from the signal. Said code sequence is compared in a comparison storage circuit 70. Upon correspondence, an electrical drive 82 in the lock 80 is activated, which acts on the lock mechanism 84 in an opening or closing function.

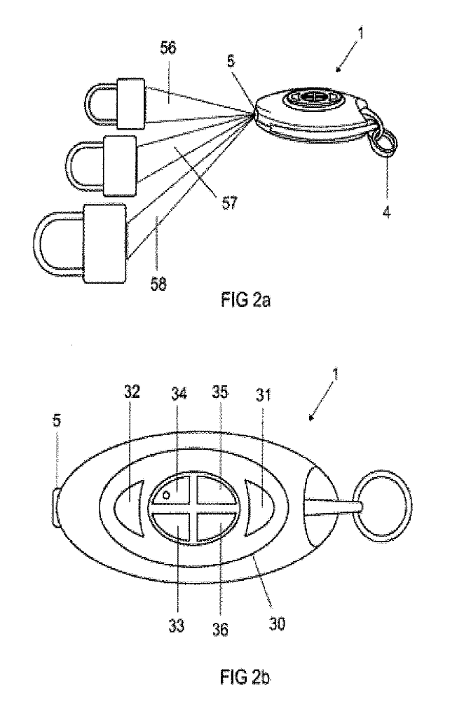

FIG. 2 shows the preferred embodiment of the key light according to the invention in a perspective view and in a plan view. In this case the key light can be of the size of radio automotive keys or else be smaller. In this case, the key light can be integrated into the user's normal bunch of keys by means of a key ring 4. On the front side, the multicolored light-emitting diode 5 is fitted which can emit different-colored focused light beams 56, 57, 58. The light beam 56 is e.g. red, the light beam 57 green, and the light beam 58 blue. These three functions can be selected by means of the three selection buttons 33, 35 and 36, which are preferably printed with the corresponding color for this purpose. The button 34 selects the orientation light. In order that the latter can be selected particularly easily, it is provided with an elevation, such that it can also be found ‘blind’.

The key light according to the invention affords the following advantages over the known mechanical keys from the prior art:

Since the key no longer has to be inserted into a mechanical lock, closing and opening become more convenient and easier.

No mechanical wear occurs.

The locking mechanism can be hidden, thereby making it more difficult to locate the lock and thus break open the latter.

The code sequence can be changed easily. If the key has a receiver, the lock can even allocate new code sequences to the key in order to make it more difficult to decrypt the code sequences.

The key light according to the invention affords the following advantages over the known keys based on a radio technology from the prior art:

Light can be concentrated very easily. This also provides inherent security against interception by comparison with radio technologies, which usually emit in all directions.

An unlicensed frequency band is used for the wireless transmission of the key combination.

The radiation can easily be shielded and circumscribed by non-transparent objects, which constitutes additional security against interception.

The achievable noise power ratio, and hence the detectability of the transmitted symbols, decreases with distance to a significantly greater extent than in the case of radio technologies. This ensures additional security against interception.

The key light according to the invention affords further advantages over the known keys based on an infrared technology from the prior art. One of the essential distinguishing features by comparison with other wireless key technologies is the visibility of light. The following advantageous properties can be derived from this:

In contrast to invisible infrared radiation the orientation of the light can easily be realized on account of the visibility thereof.

By virtue of the fact that the orientation is much easier and more systematic than in the case of infrared keys, the light emission angle can be significantly reduced by comparison with that of typical infrared keys. As a result, by way of example, the quantity of light required for the transmission can be limited very easily (small emission angle). Moreover, by means of a dynamic adaptation of the emission angle, e.g. by means of a lens, the range of the key can also be dynamically regulated without the key function being impaired in the process.

This dynamic adaptation can also be used to increase the battery lifetime (seeking the lock detector with a large emission angle, then concentration of the beam, initiation of the code sequence and readjustment until the luminous flux is high enough that the key sequence is transmitted to the lock without any errors; in addition, the transmission of the key sequence becomes virtually uninterceptable as a result of this procedure).

Increased security against interception is provided (by comparison primarily with radio technologies, but also with infrared technologies, since the user can see whether other photodectors are situated in the range of the light cone.

Furthermore, the key can additionally also be used as an orientation light if the user is in dark surroundings. Two functional units—flashlight and key—are thus merged with one another to form a single unit.

Higher psychological acceptance than in the case of radio technologies and infrared technologies is accorded (the user sees the radiation and knows from experience that—weak—light is not harmful.

The use of so-called RGB light-emitting diodes makes it possible to signal, by means of color change, when the key is transmitted. Consequently, the user can control whether the key sequence is actually transmitted and at what point in time it is transmitted (increased robustness and security against interception).

1. A key with a key light function comprising at least one light source, a storage circuit for storing at least one code sequence, and a driver unit (10), which converts the stored form of the code sequence into a driving output for the light source, wherein the code sequence can be emitted by the light source at a wavelength visible to humans by means of a temporal or color variation of the luminous flux, and the light source also be used as an orientation light.

2. The key as claimed in claim 1, wherein the light source is a semiconductor light source.

3. The key as claimed in claim 1, wherein the code sequence is emitted continuously in order to use the resulting light as an orientation light.

4. The key as claimed in claim 1, wherein that the light source either emits a code sequence by means of visible light or continuously emits the visible light.

5. The key as claimed in claim 1, comprising a first switch for activating the light source.

6. The key as claimed in claim 5, comprising first and second switches, wherein the first switch causes the light source to emit continuously and the second switch initiates the emission of the code sequence.

7. The key as claimed in claim 1, wherein the light source is adapted to emit light in a plurality of colors.

8. The key as claimed in claim 7, wherein the code sequence is emitted in a different color than the continuous light.

9. The key as claimed in claim 8, wherein the key adapted to store a plurality of code sequences.

10. The key as claimed in claim 9, wherein different code sequences are emitted in different light colors or wavelengths.

11. The key as claimed in claim 10, comprising a plurality of switches or pushbuttons for the selection of the different code sequences and also the continuous light, and at least one switch or pushbutton for activating the previously selected function.

12. The key as claimed in claim 11, comprising a dedicated switch or pushbutton respectively for the functions of unlocking and/or locking.

13. The key as claimed in claim 8, wherein the continuous light is emitted as white light having at least three different wavelengths.

14. The key as claimed in claim 1, comprising a light-sensitive receiver for receiving light signals.

15. The key as claimed in claim 14, wherein the receiver is the light source itself.

16. The key as claimed in claim 1, comprising a rechargeable battery.

17. The key as claimed in claim 1, comprising optical components by means of which the emitted light from the light source can be focused forward in at least two stages.
